(19) United States
(12) Patent Application Publication
(10) Pub. No.: US 2016/0198202 A1
(43) Pub. Date: Jul. 7, 2016

(54) Digital Rights Management for Segmented Content

(71) Applicants: KONINKLIJKE KPN N.V., The Hague (NL); NEDERLANDSE ORGANISATIE VOOR TOEGEPAST- NATUURWETENSCHAPPELIJK ONDERZOEK TNO, 's-Gravenhage (NL)

(72) Inventors: Ray Van Brandenburg, The Hague (NL); Menno Bangma, The Hague (NL); Hendrik Van De Vlag, The Hague (NL)

(21) Appl. No.: 14/650,841

(22) PCT Filed: Dec. 10, 2013
(86) PCT No.: PCT/EP2013/076006

§ 371 Date: Jun. 9, 2015

(30) Foreign Application Priority Data
Dec. 10, 2012 (EP) 12196267.4

(51) Int. Cl. H04N 21/254; G11B 27/10; H04N 21/845; H04N 21/241; H04N 21/6334; H04N 21/2347; H04N 21/854; H04N 21/4627; H04N 21/426

(52) U.S. Cl. CPC H04N 21/2541; H04N 21/4627; G11B 27/10; H04N 21/8456; H04N 21/42623; H04N 21/63345; H04N 21/2347; H04N 21/85406; H04N 21/241

(57) ABSTRACT

A method and a system for enabling delivery of at least part of a digital rights management (DRM) protected segmented content item to a content processing device is described wherein segmented content item is associated with a manifest file, comprising at least a first segment identifier associated with a first segment being encrypted on the basis a first key; and, a second segment identifier associated with a different, second, segment being encrypted on the basis of a second key; said manifest file further comprising key information for enabling decryption of at least one of said first and second encrypted segments. Said method may comprise: a secure module, preferably a DRM module, in said content processing device requesting a DRM server access to at least part of said segmented content item; and, providing said secure module access to at least part of said key information, if said content access request is granted by said DRM server.

### FIELD OF THE INVENTION

The invention relates to digital rights management of segmented content, and, in particular, though not exclusively, to a method and a system for enabling digital rights management of segmented content, a content processing device, a DRM module, a DRM server and a database structure for use in such system and a computer program product for using such method.

### BACKGROUND OF THE INVENTION

Content providers generate and sell content and sometimes deliver the content directly to a buying consumer. Often however the delivery of the content to a consumer is outsourced to an intermediate party, a content distributor, which is configured to control a content distribution platform comprising one or more content delivery networks (CDNs) for efficiently delivering content to large numbers of users. CDNs are especially suited for delivery of so-called segmented (video) content. For example, adaptive streaming techniques such as HTTP adaptive streaming (HAS) and Scalable Video Coding (SVC) and spatially segmented video techniques (e.g. tiled video) use segmentation on the basis of time, quality and space respectively. A segment may also be referred to as a chunk.

The primary reason for this segmentation is that it allows clients to seamlessly switch between different quality levels (representations) during content play-out. By making each segment available in multiple qualities, a client may select a new quality level on each segment boundary on the basis of current network conditions.

A so-called manifest file describes the temporal (and in some cases spatial) relation between the different segment files and/or streams. To that end, a manifest file may comprise segment identifiers (segment names), location information (e.g. URLs or URIs) associated with the segment identifiers and segment play-out information regarding the temporal relation between segments, which is needed to achieve continuous play-out of the segments. The manifest file enables a client to request segments from the network and to render the segments into a continuous video for play-out.

Segments identified in the manifest file may be retrieved by a file retrieval protocol, e.g. HTTP or FTP. Alternatively, segments identified in the manifest file may be retrieved using a streaming protocol, e.g. RTSP/RTP. A segment file or segment stream hereafter will be referred to as a segment. Further, a video or audio title, TV program, a live streaming event or more in general, a content item rendered by a segmentation scheme may be referred to as segmented content item.

An important responsibility of a content distributor is to make sure that it only delivers content to those users who have obtained the rights to access it. Delivering content via a third party on the basis of a CDN or a network of CDNs, comprising multiple copies of content items, may substantially increase the risk of unauthorized access to content (signal theft) and unauthorized (re)distribution of content (content theft). For that reason content protection systems like Digital Rights Management (DRM) systems are used to reduce the risk of signal or content theft, and to allow only authorized consumers and systems accessing it.

Hartung et al (“DRM Protected Dynamic Adaptive HTTP Streaming”, MMSys '11, Feb. 23-25, 2011, San Jose, USA) propose a hierarchical key distribution and license scheme wherein users can subscribe to groups of TV channels (groups of content items) of specific qualities of content (e.g. SD only or SD/HD). The proposed key distribution scheme includes a segment key (SK) for encrypting individual segments and a representation key (RK) for encrypting individual segment keys, which are also encrypted and inserted as an MPEG-4 file box in a segment. A representation key is the same for all encrypted segments of a given representation, e.g. a particular quality, viewing angle, etc. In order to allow for pay-per-view services, the RK is unique for each TV program, and is provided to users via a DRM system.

The proposed key distribution system however has some substantial disadvantages. One disadvantage is that it proposes a key distribution scheme wherein the key information for decrypting the encrypted segments is embedded in the segmented content itself. As a consequence, the DRM scheme is rather inflexible as it treats the segments as well as the keys in a strictly hierarchical manner: e.g. HD users have all rights that SD user have, and subscribers have all the rights that pay-per-view customers have. It is not possible for a SD user to have access to content that is not available to the HD user as the SD key is derived from the HD key and therefore accessible to the HD user. This hierarchy limits the flexibility of the proposed DRM scheme.

A further disadvantage is that it only allows the use of encrypted segments in a single context, e.g. as part of a TV channel. Due to the relation between the SKs and RK, a user who has access to the RK can decrypt all segments, thereby not allowing the re-use of only a subset of these segments as part of another content item.

Hence, while the method may be suitable for a simple TV use case as e.g. described in the article of Hartung, the proposed key distribution scheme is not suitable for more complex use cases of segmented content wherein there is no clear hierarchy between the segments in different content items and wherein segments may be used in different content items.

For example, in the case of sports matches or news programs, the same content may be sold or experienced in a number of different ways, as part of different sellable content items. One group of users may have the right to view the entire live football match, another group may have the right to view a football match from different viewing angles, whereas another group only has the right to view from one viewing angle (an therefore has a static view), and yet another group may only have the right to view a 10-minute summary. Further differentiation can be made using different audio commentary tracks.

A further example is 3D TV, which often makes use of streams coming from two or more different camera positions. Some groups may have access to two or more of these streams for enjoying 3D TV, whereas others may only have access to a certain one of these streams, which may be watched in simple 2D. Another example may relate to the personalization of news programs. A news program may be personalized by only including those news items that a user is interested in. In this case, where a news production might consist of large numbers of independent news items, there might be thousands of possible permutations.

Further, not all versions of a content item may be available at the moment of content creation and segmentation. For example, the owner of the football content might decide to create a new extended and commented summary version two months after the original segments where created and provided to a CDN for access. Ideally, such a scenario should be possible without having to modify the original segments, re-encrypt them, or upload a new version.

In the above-mentioned examples of personalized segmented content there is no strict hierarchy between the different segments and segment qualities that may allow implementation of the DRM scheme as proposed by Hartung et al.

More in general, known DRM systems do not allow for flexible scenarios without having to perform a separate DRM rights exchange for all segments in a content item (or at least a substantial part of all segments). Since a segment based DRM rights exchange may be a fairly complex and expensive process, in which numerous round-trip-times (RTTs) and multiple parties are involved, such scheme would not work in practice as it is not scalable and would lead to unacceptable data traffic in the network.

Hence, there is a need in the art for methods and systems that provide for a secure and flexible DRM schemes for segmented content. In particular, there is a need in the art for DRM schemes for segmented content that allow access to encrypted segments which may be part of different content items.

### SUMMARY OF THE INVENTION

It is an objective of the invention to reduce or eliminate at least one of the drawbacks known in the prior art. In one aspect the invention may relate to a method for enabling delivery of one or more digital rights management (DRM) protected segments to a content processing device. Said one or more segments may be associated with a manifest file, comprising at least a first segment identifier associated with a first segment being encrypted on the basis a first key; and, a second segment identifier associated with a different, second, segment being encrypted on the basis of a second key. Said manifest file may further comprise key information for enabling decryption of at least one of said first and second encrypted segments respectively. Said method may comprise: a secure module, preferably a DRM module, in said content processing device requesting a DRM server access to at least one of said segments; and, providing said secure module access to at least part of said key information, if said content access request is granted by said DRM server.

Hence, the manifest file comprises key information for enabling decryption of encrypted segments, wherein the key information is linked to the manifest file. As this key information is only provided to, and/or can only be used by a requesting content processing device when it is authorized to access the content, effective protection of segmented content defined in a manifest file is provided.

In an embodiment, said manifest file may define a segmented content item (a media file or stream) comprising a set of segments. In another embodiment, said manifest file may define a segmented content collection comprising segments selected from a set of segments defining a content item; or, comprising one or more segments selected from different sets of segments defining different content items. The sets of segments may be stored in the network, e.g. at one or more delivery nodes.

In contrast with prior art solutions, the invention provides a flexible DRM scheme that allows both delivery of conventional segmented content items and “personalized” content collections. Content collections may be formed by creating a manifest file that identifies segments which belong to different content items and which are stored in the network. The segments identified in the manifest file may be selected on the basis of user data associated with the content processing device.

In an embodiment, said manifest file may further comprise segment play-out information on the temporal relation between the segments.

In an embodiment said method may comprise: said secure module receiving said key information comprising at least one of a first and second decryption key for decrypting said first or said second segment respectively; or, said key information comprising a reference, preferably an resource locator or a network address, to a network entity comprising at least one of a first and second key decryption key, if said content access request is granted by said DRM server. Hence, the invention provides a digital rights management scheme (DRM) for segmented content items and delivery of segmented content protected by such DRM scheme wherein different segments in a segmented content item are encrypted using different encryption keys. The fact that each segment is individually encrypted prevents the content consumer from decrypting encrypted segments that are not included in the content item that is purchased. Unauthorised access to encrypted content items is prevented or at least more difficult, since a separate encryption (decryption) key is required for each segment in order to fully decrypt a content item comprising a plurality of (encrypted) segments.

In an embodiment at least part of said key information in said manifest file may be encrypted on the basis of a manifest-specific encryption key. In another embodiment said method may comprise: said secure module receiving a manifest-specific decryption key for decrypting said encrypted part of said key information, if said content access request is granted by said DRM server. Hence the providing of access to key information may be achieved by providing a manifest-specific decryption key that is suitbale for decrypting the key information. In such embodiment, absent this decryption key, the secure module cannot interpret/use the key information, and therefore has no access to the key information (in its encrypted state). Only a single DRM rights exchange is required to enable the decryption of all the segments identified in a manifest file. The method therefore enables an improved protection and delivery of DRM-protected segmented content, while still allowing for an efficient and flexible management of the digital rights.

In an embodiment said manifest-specific decryption key may be provided in encrypted form with a user-specific or device-specific encryption key, and wherein a decryption key for decrypting said encrypted manifest-specific decryption key may be delivered when the content is purchased or ordered. This way a further security layer may be formed which is device- or user-specific. An advantage of this embodiment is that it may allow a content provider to make sure that a given content item is only played out on a specific device or by a specific user.

In an embodiment said key information may comprise at least one of a first and second decryption key for decrypting said first or said second segment respectively; or, wherein said key information comprises a reference to a network entity comprising said first and/or second decryption key. In an embodiment said reference may be an resource locator or a network address.

Here the manifest file may provide the secure module (e.g. a DRM module) with decryption keys for decryption the segments or with a link to a location, e.g. a key server, where the decryption keys can be retrieved. If a scrambling algorithm or a symmetric key algorithm is used, the same key is used for both encryption (scrambling) and decryption (descrambling). If an asymmetric key algorithm is used, an encryption key is used for encrypting and an associated decryption key is used for decrypting a segment.

In an embodiment said first key may be encrypted using a first segment-specific encryption key and wherein said key information comprises a first segment-specific decryption key for decrypting said encrypted first key. A segment-specific decryption key is also referred to as a chunk-specific decryption key.

In an embodiment said key information may comprise different parts associated with (suitable for) different DRM schemes or systems. Said at least part of said key information may thus relate to key information associated with a particular DRM scheme. The advantage may be that the manifest file may thus be provided without knowledge of the particular DRM schedule used/the particular DRM module implemented in a content processing device.

In an embodiment said method may comprise: receiving said encrypted first segment and said encrypted first key; preferably said encrypted first segment and said first encrypted first key being received using the same (MPEG-based) data container; receiving said first segment-specific decryption key; decrypting said encrypted first key on the basis of said first segment-specific decryption key; decrypting said encrypted first segment using said first key. Hence, the DRM protection scheme according to the invention allows a flexible multi-layered protection scheme for segmented content, which is compatible with existing content protection schemes which are e.g. used in broadcast scenarios.

In an embodiment said manifest file may further comprise location information associated with a delivery node for delivering said first and/or second segment; and, optionally. The manifest file may comprise location information for locating a delivery node in the network.

In another embodiment said method may further comprise: sending a request for the delivery of a segment to said delivery node; receiving said first and/or second encrypted segment; decrypting said first and/or second encrypted segment on the basis of said key information.

In an embodiment one or more representations of a content item or a content collection may be associated with one or more viewing angles of content in said content item, one or more different advertisements in said content item, one or more different audio and/or subtitles in said content item; and/or one or more spatial (tiled) representations of said content item or content collection.

In yet another embodiment wherein said content processing device may comprise: a client configured for requesting and receiving encrypted segments from the network on the basis of said manifest file; and/or, a secure module, preferably a DRM module, configured for requesting a DRM server a right to access at least part of the encrypted segments and for receiving at least part of said key information from said DRM server or from said client.

In yet another embodiment, said encrypted segments may be delivered by at least one content delivery network, preferably one or more delivery nodes in said at least one content delivery network, to said content processing device.

In another aspect, the invention may relate to a system for enabling delivery of one or more digital rights management (DRM) protected segments to a content processing device, wherein said segments may be associated with a manifest file, said manifest file comprising at least a first segment identifier associated with a first segment being encrypted on the basis of a first key; a second segment identifier associated with a second segment being encrypted on the basis of a second key; said manifest file further comprising key information for enabling decryption of at least one of said first and second segment.

In an embodiment, said manifest file may define a segmented content item (a media file or stream) comprising a set of segments. In another embodiment, said manifest file may define a segmented content collection comprising segments selected from a set of segments defining a content item; or, comprising one or more segments selected from different sets of segments defining different content items.

In an embodiment said system may comprise: a secure module, preferably a DRM module in said content processing device, configured for requesting a DRM server access to at least part of said segmented content item; and, a DRM server configured for providing said secure module with at least part of said key information, if said request for access is granted.

In a further aspect, the invention may relate to a DRM module for digital rights management of one or more DRM protected segments, wherein said segments may be associated with a manifest file, said manifest file comprising at least a first segment identifier associated with a first segment being encrypted on the basis of a first encryption key; a second segment identifier associated with a second segment being encrypted on the basis of a second encryption key; and, said manifest file further comprising key information for enabling decryption of at least one of said first and second segment.

In an embodiment, said manifest file may define a segmented content item (a media file or stream) comprising a set of segments. In another embodiment, said manifest file may define a segmented content collection comprising segments selected from a set of segments defining a content item; or, comprising one or more segments selected from different sets of segments defining different content items.

In an embodiment, said secure module (e.g. a DRM module) may comprise: means (e.g. a transmitter) for sending a content access request for accessing at least one of said segments to a digital rights server; means (e.g. a receiver) for receiving at least part of said key information if said content access request is granted by said digital rights server; and, means (e.g. a decryption module) for decrypting at least one of said first and second encrypted segments on the basis of said key information. In an embodiment, said first or second segment may be part of a second DRM protected segmented content item defined by a second manifest file. In further embodiments, said decryption module may be communicatively connected to the DRM module (instead of being part of it), for example as a separate module within the content processing device or as part of the (HAS) client.

In yet another aspect, the invention may relate to a server for digital rights management of one or more DRM protected segments, wherein said segments are associated with a manifest file, said manifest file comprising at least a first segment identifier associated with a first encrypted segment encrypted using a first encryption key; a second segment identifier associated with a second encrypted segment encrypted using a second encryption key; and, said manifest file further comprising key information for enabling decryption of said first and second segments respectively.

In an embodiment, said manifest file may define a segmented content item (a media file or stream) comprising a set of segments. In another embodiment, said manifest file may define a segmented content collection comprising segments selected from a set of segments defining a content item; or, comprising one or more segments selected from different sets of segments defining different content items.

In an embodiment, said server may comprise: a receiver for receiving from a DRM module a request for accessing at least one of said segments. In another embodiment said server may comprise a transmitter for sending at least part of said key information, if said request for access is granted.

In yet a further aspect, the invention may relate to a content processing device for receiving one or more DRM-protected segments, wherein content processing device is configured to receive said one or more segments on the basis of a manifest file, said manifest file comprising at least a first segment identifier associated with a first segment being encrypted on the basis of a first encryption key; a second segment identifier associated with a second segment being encrypted on the basis of a second encryption key; and, said manifest file further comprising key information for enabling decryption of at least one of said first and second segment.

In an embodiment, said manifest file may define a segmented content item (a media file or stream) comprising a set of segments. In another embodiment, said manifest file may define a segmented content collection comprising segments selected from a set of segments defining a content item; or, comprising one or more segments selected from different sets of segments defining different content items.

In an embodiment said content processing device may comprise: a client configured for requesting and receiving said first and/or second encrypted segment on the basis of said manifest file; a DRM module configured for receiving said first and/or second encrypted segment from said client, for receiving at least part of said key information from a DRM server; and/or, for decrypting at least part of said first and/or second encrypted segment using said at least part of said key information. Instead of the DRM module comprising the functionality for decryption (e.g. a decryption module), the content processing device may comprise a separate decryption module communicatively connected to the DRM module and or the client, for decrypting segments and/or decryption keys.

In a further aspect, the invention may relate to a data structure, preferably a manifest file for use by a content processing device as described above, said data structure enabling digital rights management of one or more DRM protected segments, wherein said segments are associated with a manifest file, said manifest file comprising at least a first segment identifier associated with a first segment being encrypted using a first key; a second segment identifier associated with a second segment being encrypted using a second key; and; said manifest file may comprise key information for enabling decryption of said at least one of said first and second segment.

In an embodiment, said manifest file may define a segmented content item (a media file or stream) comprising a set of segments. In another embodiment, said manifest file may define a segmented content collection comprising segments selected from a set of segments defining a content item; or, comprising one or more segments selected from different sets of segments defining different content items.

In an embodiment said key information may comprise:

at least one of a first and second decryption key for decrypting said first or said second segment respectively; or, wherein said key information comprises a reference, preferably an resource locator or a network address, to a network entity comprising said first and/or second decryption key.

In another embodiment, said key information may comprise: a first segment specific decryption key and/or second segment specific key; or a reference to said first and/or second segment specific decryption key, said first and second segment specific decryption key being used for decrypting said first and second key respectively.

In yet another embodiment, said key information or at least a part of said manifest file comprising said key information, may be encrypted using a manifest key. In an embodiment said manifest key may be a manifest file specific encryption key.

In a further aspect the invention may also relate to a method for enabling digital rights management (DRM) of segmented content comprising: a content processing device receiving a first segment encrypted with a first key and a second segment encrypted with a second key; and, a content processing device receiving at least part of a manifest file, said manifest file comprising a first segment identifier associated with said first encrypted segment; and, first key information enabling decryption of said first encrypted segment, wherein said first key information only enables decryption of said first encrypted segment.

In an embodiment said method may comprise: providing said content processing device with at least part of said first key information if said content processing device is authorized by a DRM server.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the users computer, as a stand-alone software package, partly on the users computer and partly on a remote computer, or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The invention may also relate to a program product, a computer program product comprising software code portions configured for, when run in the memory of a computer, executing the method steps as described above. The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1A depicts a schematic of a content delivery system comprising a digital rights management system according to one embodiment of the invention.

FIG. 1B depicts a process for creating content item representation according to an embodiment of the invention.

FIG. 2 depicts a schematic of a manifest file according to one embodiment of the invention.

FIG. 3 depicts a protocol flow of a DRM-protected streaming process according to one embodiment of the invention.

FIG. 4 depicts a schematic of a manifest file according to another embodiment of the invention.

FIG. 5 depicts the protocol flow of a DRM-protected streaming process according to another embodiment of the invention.

FIG. 6 depicts a schematic of a manifest file according to a further embodiment of the invention.

FIG. 7 depicts a schematic of a content delivery system comprising a digital rights management system according to another embodiment of the invention.

FIG. 8 depicts a schematic of a manifest file according to yet a further embodiment of the invention.

FIG. 9 depicts a protocol flow of a DRM-protected streaming process according to yet another embodiment of the invention.

FIG. 10 depicts a schematic of a spatially segmented video.

### DETAILED DESCRIPTION

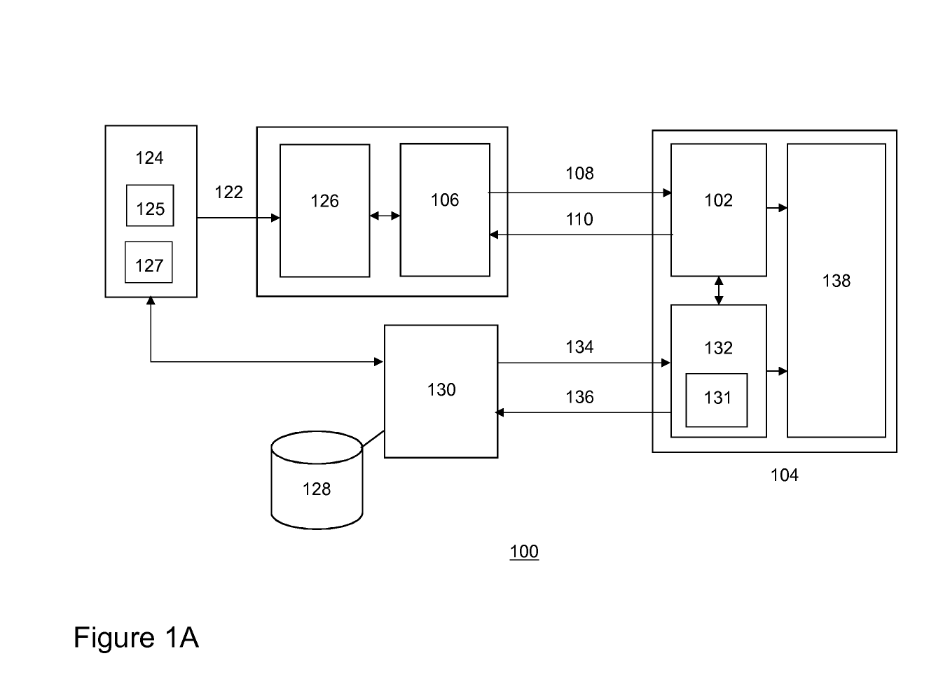

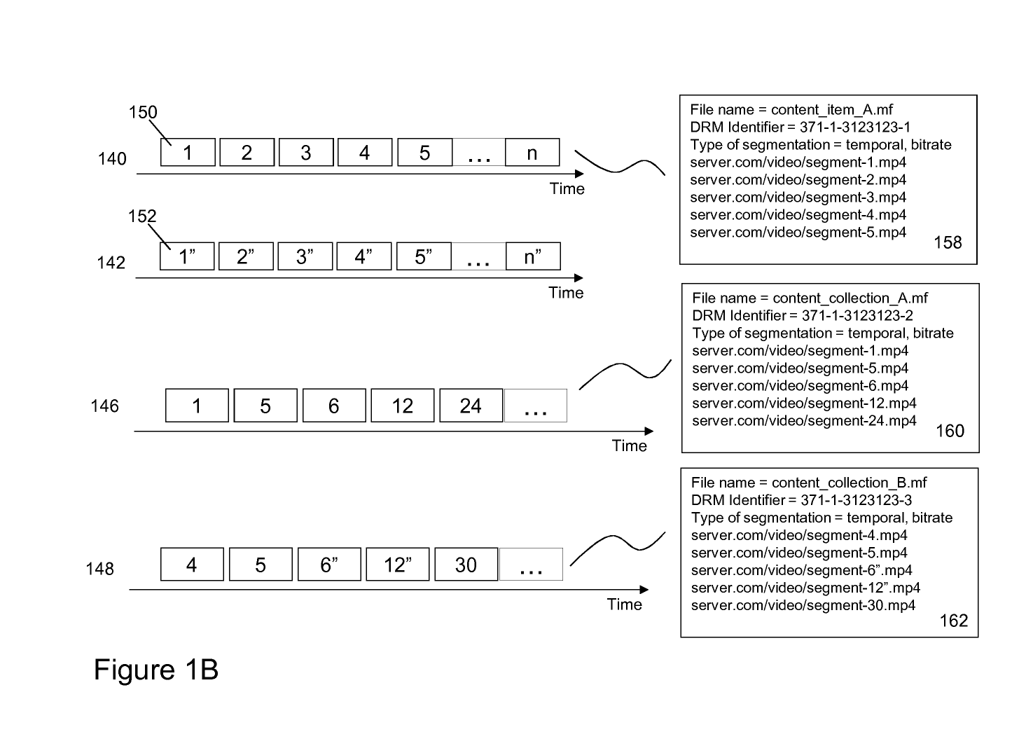

FIG. 1A depicts a schematic of a content delivery system 100 comprising a DRM system according to one embodiment of the invention. In particular, FIG. 1A depicts a client 102 in a content processing device 104 and one or more delivery nodes 106, which are configured to deliver DRM-protected segmented content items to the content processing device.

Here the DRM system is used to protect the copyrights of digital music and movies, as well as other data that is stored and transferred to the content processing devices. A DRM system may enable a content provider to distribute protected (encrypted) content and service providers (rights issuers) to issue DRM Licenses (Rights Objects) for the protected content. When a user wants to access the content, it should acquire a DRM License from the rights Issuer. The license contains permissions and keys to “access” the protected content. As the content is cryptographically protected when distributed, the protected content cannot be accessed without an associated DRM license (rights object) issued for the content processing device.

The client 102 and a delivery node may be configured to communicate with each other on the basis of an adaptive streaming protocol, e.g., such as Apple HTTP Live Streaming [http://tools.ietf.org/html/draft-pantos-http-live-streaming-07], Microsoft Smooth Streaming [http://www.iis.net/download/SmoothStreaming], Adobe HTTP Dynamic Streaming [http://www.adobe.com/products/httpdynamicstreaming], 3GPP-DASH [TS 26.247 Transparent end-to-end Packet-switched Streaming Service (PSS); Progressive Download and Dynamic Adaptive Streaming over HTTP] and MPEG Dynamic Adaptive Streaming over HTTP [MPEG DASH ISO/IEC 23001-6]. Such streaming protocol, based on request and response protocol messages 108,110, allows control of the media streaming process between the delivery node and the content processing device.

The content processing device may generally relate to a (mobile) content play-out device such as an electronic tablet, a smart-phone, a notebook, a personal computer, a media player, a home gateway or DASH enabled devices such as a DASH-enabled HbbTV display device. Alternatively, the content processing device may be a set-top box or content storage device configured for processing and temporarily storing content for future consumption by a content play-out device, which has access to the stored content.

Similarly, a delivery node may relate to a media server, part of a network of media servers, a server associated with a content provider system or a content delivery network (CDN) system. Segments 122 associated with (parts of) different content items may be provided by a content provider 124 to the delivery node (or a content management system 126 associated with the delivery node).

When requesting a particular content item, the content provider or the delivery node may provide the client with a manifest file (also known as a Media Presentation Description or MPD for MPEG-DASH or M3U8 playlist for Apple HTTP Live Streaming). Here, the term “manifest file” may generally refer to a special data structure, which may comprise segment identifiers (descriptors) identifying the segments forming a content item, e.g. a video title, and segment play-out information for determining the temporal relation between the segments and/or the temporal relation of data (e.g. video frames) within a segment. The segment play-out information may be used by the client to correctly determine a sequence of segments for play-out. The manifest file may further comprise location information of a (set of) network node(s), e.g. media server(s), which may be configured to either deliver the segments to the client or to provide the client with information where the segments may be retrieved.

At least part of the segments of a content item may be encrypted or scrambled on the basis of a predetermined cryptosystem or scrambling system in order to protect the segmented content against unauthorized access during storage in the network and during delivery of the segments to a content processing device. A cryptosystem or scrambling system may comprises at least one key generating module 125 comprising a key generating algorithm for generating keys, encryption (scrambling) module 127 comprising an encryption (scrambling) algorithm for encrypting (scrambling) data in a segment on the basis of at least one key; and, a decryption (descrambling) module 131 comprising a decryption (descrambling) algorithm for decrypting (descrambling) encrypted data in a segment on the basis of at least one key.

In one embodiment, a cryptosystem may be used comprising a symmetric key algorithm. Symmetric-key algorithms are a class of algorithms for cryptography that use the same key for both encryption of plaintext and decryption of ciphertext. The key may be identical or there may be a simple transformation to go between an encryption and decryption key.

In another embodiment, a scrambling system may be used comprising a scrambling algorithm to scramble (encrypt) a segment on the basis of a key (in DVB often referred to as a control word) and a descrambling algorithm to descrambled (decrypt) a scrambled segment on the basis of the same key.

In yet another embodiment, a cryptosystem may be used comprising an asymmetric key algorithm. Asymmetric-key algorithms are a class of algorithms for cryptography that use encryption key for encryption of plaintext into ciphertext on the basis of an encryption algorithm and a different decryption key for decryption of ciphertext on the basis of a decryption algorithm.

It is submitted that in this application, the term encryption may also include scrambling, i.e. the process of adding components to the original signal or the changing of some important component(s) of the original signal in order to make extraction of the original signal difficult. In a scrambling process, which is commonly used in DVB (as it is very fast and can be accomplished in (near) real-time), data are scrambled at the transmission side and descrambled at the receiver side. Scrambling may be regarded as a “weaker” form of encryption, i.e. encoding a signal in such a way that eavesdroppers cannot read it, but that authorized parties can.

In the content delivery system of FIG. 1A, the encryption and decryption of the segmented content and the generation and distribution of keys is managed by a DRM system, which will be described hereunder in more detail.

The segments may be encrypted (e.g. by the encryption module 127 in or associated with the content provider) and provided to the delivery node in encrypted form. Encryption may be carried out using well-known encryption algorithms such as AES or DVB-CSA respectively. During the encryption process, each encrypted segment identified by a segment identifier may be associated with at least one key, which hereafter will be referred to as the Content Key (CK).

In one embodiment, the CK may be different for each segment, so that each segment is encrypted using a different key and access to each segment can be controlled individually. In another embodiment, the same CK may be used for a number of related segments.

In order to manage access to the content, the key generating module 125 may send key information that enables decryption of the encrypted segments (e.g. the Content Keys CK and associated identification information (e.g. segment identifiers) to the DRM server 130, which may store the keys and associated identifiers in a DRM database 128. In one embodiment, a segment (segment) identifier may include at least a segment name. In another embodiment, a segment identifier may further include the temporal position of the segment in the segmented content item and/or location information, e.g. an URL, for locating a delivery node, which is configured for delivering the segment associated with the segment name or for delivering information where the segment can be retrieved. The DRM database may further comprise access rights associated with users of the content delivery system. Rights may provide access to content in order to play-back the content, record the content, store the content, forward or copy the content etc. In this application, the generic term “access” to content is used to describe the various rights that are possible. When a user has access rights to a predetermined set of segments, the DRM server will grant access to the encrypted segments.

When granting access, the DRM server may enable the content processing device, in particular the DRM module in the content processing device, to decrypt encrypted segments of the content item. Hence, depending on how the encryption scheme is implemented, the DRM module may receive key information from e.g. the DRM server or a separate key server, in order to decrypt the encrypted segments. For example, in one embodiment, when the DRM server grants access to a content item, it may provide the DRM module in the content processing device access to the content keys associated with the encrypted segments so that it may decrypt the segments.

When a user of the content processing device activates the client to request (part of) a segmented content item, the client may be provided with a manifest file so that it is able to request the segments from one or more delivery nodes. When requesting access to the segmented content item, the client may activate a DRM module 132 via a secure interface between the client and the DRM module in the content processing device.

In particular, the client may activate the DRM module in order to start a DRM rights exchange with the DRM server 130. During this exchange the DRM module may send a content access request message 134 (DRM request) to the DRM server in order to check for the availability of a license, which provides the client the rights to access the requested segmented content item. If this is the case, the DRM server may send a response message 136 for granting access back to the DRM module. When access is granted, the DRM module may be provided with key information allowing the DRM module to obtain content keys (e.g. used in one or more decryption steps, such that the content processing device is able to process decrypted segments. A decryption module 131 in the DRM module may use obtained decryption keys to decrypt the data in the segments and gain access the requested content. Alternatively the decryption module 131 may be communicatively connected to the DRM module, and for example implemented as a separate module (for example comprising one or more separate microprocessors, circuitry and memory space) within the content processing device, or as part of the client (module).

As will be described hereunder in more detail, different content protection schemes, e.g. single or multi-layer content protection schemes, may be used to protect access to the segments. Different key distribution schemes may be implemented in order to provide the DRM module with the content keys.

Hence, if the DRM response indicates that the client is allowed to access the requested content, the client may start requesting encrypted segments from the content delivery node. The received encrypted segments may be buffered and forwarded to the secure DRM module, which may use the content keys in order to decrypt the segments into cleartext, which is subsequently forwarded to a decoder and display module 138 of the content processing device directly or via the HAS client.

As will be described hereunder in more detail, the content keys may be provided to the DRM module in various ways. For example, in one embodiment, at least part of the content keys may be sent in a manifest file to the DRM module. In that case, the DRM module will have to parse the manifest file and provide the client with the segment identifiers in order to enable the client to retrieve the segments associated with the requested content item. Alternatively and/or in addition, at least part of the content keys may be sent by the DRM server to the DRM module, while the manifest file comprising the segment identifiers associated with the content keys may be provided by the delivery node to the client. In that case, the DRM module will have to relate encrypted segments received by the client to content keys it has received from the DRM server.

The DRM module 132 in the content processing device may be implemented as dedicated secure hardware module (including circuitry and/or microprocessor and possibly memory space), a secure software implementation or a combination thereof. The DRM module and the decoder and display module are configured to execute the decryption of the segments, the decoding of the clear text and the subsequent play-out of the content in a secure environment so that unauthorized access to the cleartext is not possible or at least very difficult.

In the system depicted in FIG. 1, the DRM server and DRM client may form as secure environment in which sensitive key information, such as content keys or further (decryption) keys may be exchanged in a secure way. Communication between the DRM server and DRM module may be established over a secure channel using for example a SSL/TLS-based protocol or a variant thereof. In case the client and delivery node are fully implemented in a secure environment, the functionality of the DRM server and the DRM module may be integrated in the delivery node and the client respectively.

In the content delivery system of FIG. 1A, segments associated with different content items may be (temporarily) stored or—in case of (live) streaming—made available at the one or more content delivery nodes in a network. For example, a CDN may store the segments or make segments available at different nodes in order to guarantee efficient delivery of the segments to a large number of content processing devices.

In that case, in one embodiment, the content management system may be configured to create a “new” content item on the basis of the segments that are already created and available in the network. This new content item hereafter will be referred to as content collection.

A content collection may be simply formed by creating a new manifest file that may include references to encrypted segments belonging to another content item that is stored in the network. Alternatively, the new manifest file may include references to encrypted segments belonging to a plurality of different content items. As will be described hereunder in more detail, the formation of a content collection does not require replication of segments so that (CDN) storage costs and bandwidth in the core network can be saved.

FIG. 1B depicts a process of creating one or more content collections on the basis of segment originating from one or more content items. The process may be executed by the content delivery system as described with reference to FIG. 1A. Segmented content items, e.g. a first and second segmented content item 140,142, may be formed by segmenting a first and second media file (or stream) respectively into a predetermined number of segments 150,152. An encryption module may be used to encrypt the segments on the basis of different encryption keys such that the segments are protected against unauthorized access. The encryption keys (and associated decryption keys) may be generated using a key generation module. The first and second segmented content item are defined by a first and second manifest file 158 respectively, wherein each manifest file may comprise segment identifiers and segment play-out information regarding the temporal relation between the segments identified in the manifest file, may define. The encrypted segments and the associated manifest files may be stored or made available at one or more content delivery nodes of the content delivery system.

Content collections 146,148 may be formed on the basis of the encrypted segments belonging to different content items. For example, in one embodiment, a first content collection 146 (content collection A) may be formed by selecting a predetermined subset of segments e.g. {1, 5, 6, 12, 24, . . . } from the total set of segments defining the first content item 140. The first content collection 146 may be formed by creating a new third manifest file 160 comprising the segment identifiers associated with the selected segments, location information for locating the selected segments on one or more delivery nodes and segment play-out information for determining the temporal relation between the selected segments identified in the third manifest file. The segment play-out information enables a HAS client in a content processing device to play-out the segments in a predetermined temporal order so that continuous play-out of the content may be achieved.

Hence, from the above, it follows that manifest files defining different subsets of segments selected from a set of segments of a first content item that is already stored or made available at a content delivery node may form different content collections, each of which may be sold individually, without having to create new segments. Because the content collection is based on encrypted segments that are already stored at the delivery node, no replication of segments is required.

In another embodiment, a second content collection 148 (content collection B) may be formed by selecting one or more segments {4, 5, 30} from a set of segments defining a first content item and one or more segments {6″,12″} from a set of segments defining a second content item. This second content collection 148 may be formed by generating a fourth manifest file 162 comprising the segment identifiers associated with segments selected from the first and second content items, location information for locating the selected segments on one or more delivery nodes and segment play-out information.

The manifest file of a content collection may be created on the basis of user data thereby enabling personalization of the content collection before it is streamed to a content processing device. For example, the first segmented content item 140 may relate to a particular video title and the second segmented content item may relate to advertisements. When a client requests the first content item, a “personalized” content collection may be formed by creating a manifest file comprising first segment identifiers selected from the set of segments forming the first segmented content item and one or more second segment identifiers selected from the set of segments forming the second segmented content item. The selection of the segments from the set of segments defining the first and/or second content item may depend on user data associated with client requesting content item. The user data may include location of the client, type of subscription, user statics, etc.

In one embodiment, content collections may define different versions of media file or stream. For example, a content item may relate to a video file or stream on a sports event comprising different sport items. Then, on the basis of the segments of this content item, different related content collections may be created: a first content collection related to the sport event comprising one or two sport items; a second content collection related to the a summary of the sports event; a third content collection related to the sports event comprising a special commentary, a fourth content collection related to the sports event comprising personalized advertisements, etc.)

Hereunder, a number of embodiments are described in which different content collections may be formed by creating a manifest file that refers to (encrypted) segments that are already stored or made available at one or more delivery nodes

On example of a content collection may relate to a news program that may comprise many different news items. A content consumer may only be interested in a certain type of news item (e.g. economy or sports). Hence, on the basis of the above-described content creating process, a personalised content collection may be created by selecting segments from the set of segment defining the new program that the consumer is interested in and by creating a manifest file that comprises segment identifiers of the selected segments, location information associated with the identified segments and segment play-out information.

Another example may relate to events such as the Olympic games, wherein many different television programs (different sports) are broadcasted simultaneously. It such situation is not possible to watch all the broadcasts. Viewers may have to select: which sports they are interested in; whether they want to see the full broadcast or just the summary; and, which broadcasts they want to receive in HD or SD. Segmentation of the broadcasts, encoding the segments into different qualities (SD and HD), selecting segments associated with relevant sports items and the creating a manifest file defining the content collection as described above, allows the delivery of a personalised (live) broadcast without the need to store the broadcasts of each individual user separately.

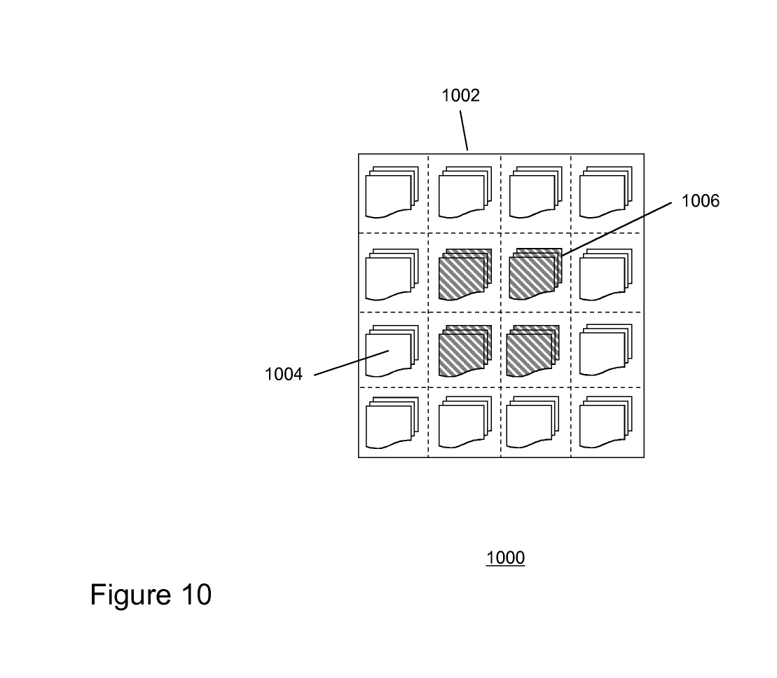

Yet another example relates to spatially segmented video content, in which frames of a complete video are subdivided into spatially separate video tiles and in which a temporal sequence of tiles may form a spatial segment (see FIG. 10 for more details). The video may for example be subdivided into (4×4) spatial segments or tiles thereby forming a spatially segmented content item. A user of a content processing device with a small display, such as a smart phone, would only be interested in viewing and purchasing the 4 centre tiles, while a user of a content processing device with a large display (e.g. a large television) may want to view and purchase all 16 tiles.

Different content collections may be formed by creating manifest files that define tiles that can be used by a particular consumer. The formation of the content collections does not require additional storage space. Spatial and temporal segmentation may also be combined. A single user may want to see the sports related news items in HD on all the 16 tiles and the economy related news items in SD, on only the 4 centre tiles.

Hence, the process depicted in FIG. 1B allows the creation of different content collections by creating a new manifest file which identifies encrypted segments that are already part of one or more other content items and that are already stored or made available at a delivery node. This way, encrypted segments may be shared by several “related” content collections so that there is no need to generate and store separate copies the segments forming a content collection.

Each segment (or at least a substantial part of the segments) in a content collection may be encrypted on the basis of different encryption keys in order to avoid unauthorized access to the content. Prior art DRM systems for HAS however do not provide the functionality that is required in order to deliver (personalized) content collections in encrypted form to HAS clients.

This problem may be solved by including key information for enabling decryption of segments referred to in the manifest file. As will be described hereunder in more detail, the key information in the manifest file enables a flexible DRM system for HAS and may comprise (encrypted) content keys for decrypting segments, (encrypted) segment (chunk)-specific decryption keys and/or a reference (e.g. an URL or network address) to at least one network location where such keys are stored. Such reference may also comprise a specific key identifier. Various embodiments of a manifest file comprising key information for enabling decryption of segments referred to in the manifest file; and, advantageous uses of such manifest files in a DRM system for HTTP Adaptive Streaming (HAS) are described hereunder in more detail.

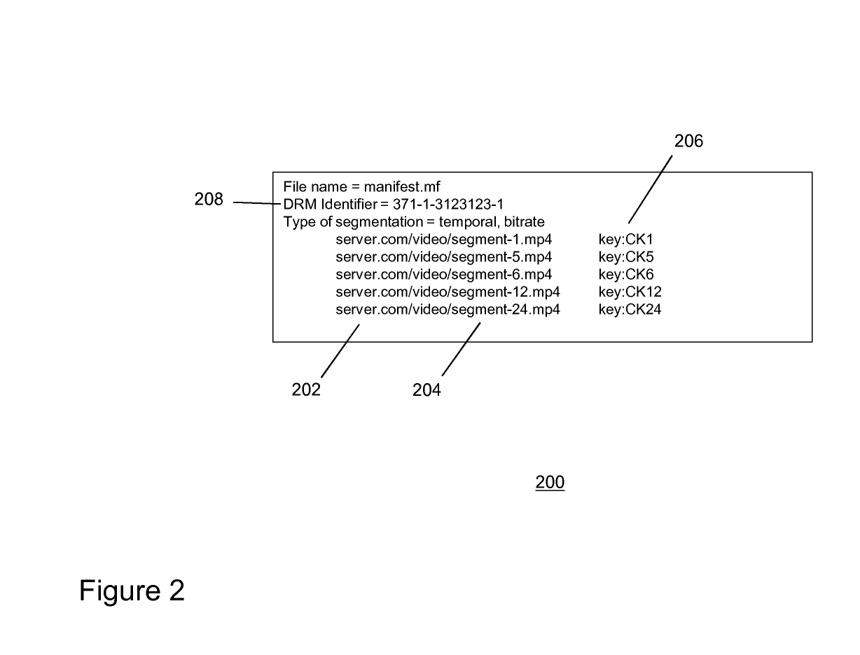

FIG. 2 depicts a schematic of at least part of a manifest file 200 according to an embodiment of the invention. In particular, FIG. 2 depicts a schematic of a manifest file, which is used by the client to locate delivery nodes configured to deliver segments identified in the manifest file to the client. The manifest file may define a content item or a content collection as described in detail with reference to FIG. 1B.

The manifest file may comprise one or more segment identifiers 204, e.g. segment file names, for identifying a segment. In an embodiment, the manifest file may comprise segment play-out information including information regarding the temporal position of a segment in a content item and/or the play-out time of the segment. In an embodiment, the temporal order in which the identifiers are listed in the file may correspond to the order in which the segments will be played back to create a continuous video stream. The manifest file may further comprise location information in the form of one or more segment locators 202 associated with one or more segment identifiers.

A segment locator may be defined as a pointer to one or more network nodes or one or more folders on a network node, which are configured to store the identified segment and to deliver the segment to a client. Alternatively, a segment locator may point to one or more network nodes, which are configured to determine one or more further network nodes, which may be able to deliver the identified segment to the client.

In some embodiments, a segment identifier and a segment locator may be part of a predetermined data structure such as an URI or URL, which may be resolved in the network into a network address, i.e. a location in the network, of a delivery node. For example, the URL server.com/video/segment-1.mp4 comprises a segment locator server.com/video, i.e. a pointer (or a reference) to a network node (a server) and a segment identifier, i.e. segment file name segment-1.mp4 wherein the server server.com may comprise a video folder in which the segment file is stored.

Although the examples hereunder are described using URLs, it is submitted that the invention is not limited thereto. In another embodiment, the segment identifiers and segment locators may take any suitable format suitable for identifying and locating segments in the network. In some embodiments, the segment identifier and the segment locator may coincide in the sense that either the segment identifier or the segment locator may be used for identifying and locating a segment in the network.

The segment identifiers in the manifest file may be associated with key information for enabling decryption of the segments associated with the segment identifiers. In an embodiment, the key information may comprise one or more content keys CKs 206 for decryption (descrambling) of encrypted (scrambled) segments. A content key CK 206 may be associated with at least one segment identifier (as shown in FIG. 2).

In another embodiment (not shown), instead of content keys, the key information in the manifest file may comprise a reference, e.g. an URI, URL or an IP address, to a (network) location comprising at least part of the content keys, e.g. a separate key server. In that case, the content keys associated with the segment identifiers may be sent via a separate secure channel to the DRM module. The DRM module may be configured for relating segment identifiers to their associated content keys.

In the embodiment of FIG. 2, the content keys are not encrypted so the content keys may be sent to the DRM module over a secure channel.

In an embodiment, the manifest file may further comprise DRM identification information 208, which may be used by the DRM module to identify information associated with a content item that is stored in the DRM server. For example, the DRM module may send the DRM identification information in a content access request message (DRM request) to the DRM server in order to check whether a user has a right to the content item identified by the DRM identification information.

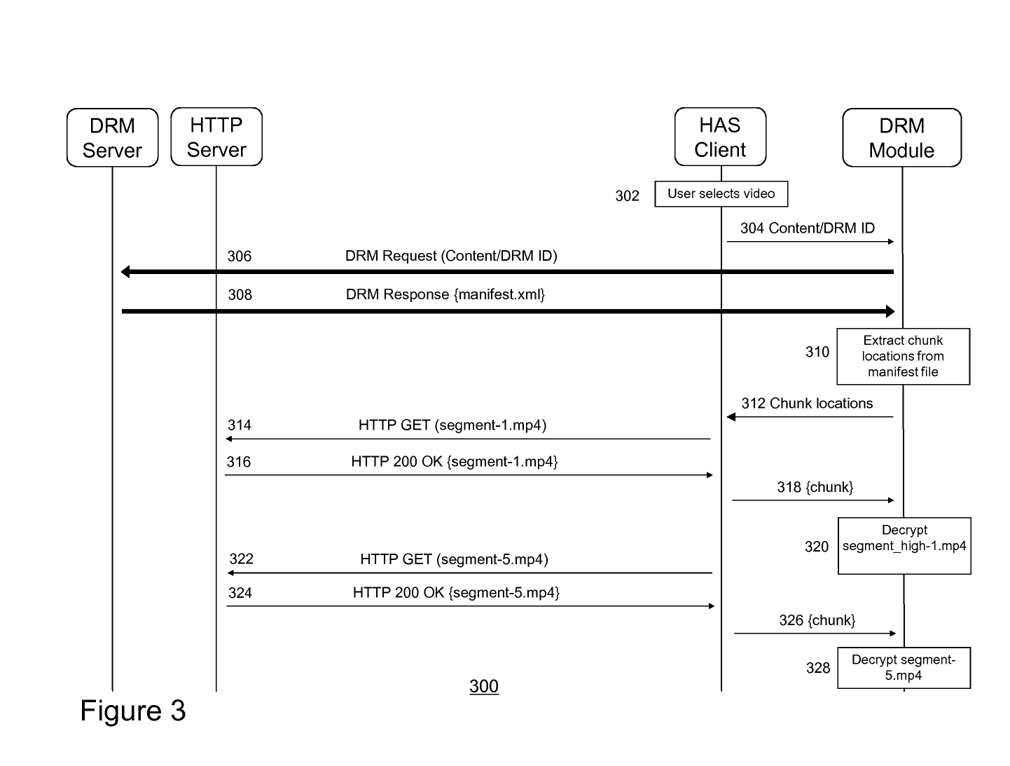

FIG. 3 depicts the protocol flow of a DRM-protected streaming process according to an embodiment of the invention.

The protocol flow in FIG. 3 may be executed by a content delivery system. The content delivery system may comprise at least a delivery node (e.g. an HTTP media server) comprising encrypted segments and a content processing device comprising a client (e.g. a HAS or an MPEG DASH client) and a DRM system comprising DRM server and a DRM module which is implemented in the content processing device and which is configured to communicate with the client. An example of such content delivery system is described with reference to FIG. 1.

The process may start by a consumer selecting a video (step 302). For example, the customer may buy a content item or a content collection, e.g. (personalized) video title, via a website of a content provider. The access rights (license) of the customer for accessing the content item or content collection may be stored in the DRM server and associated with DRM identification information (e.g. DRM ID). After obtaining an access right, the customer may—at some point in time—decide to play-out the content item or content collection by instructing the client in the content processing device (e.g. by pressing a play button).

In response, the client may first check whether the customer is still entitled to access the content item or content collection. To that end, the client may send a message to the DRM module (step 304). The message may include a content identifier (content ID) and DRM identification information (DRM ID), which are forwarded by the DRM module in a content access request message (DRM request) to the DRM server (step 306). On the basis of the content ID, the DRM ID and/or further validation information (e.g. user- or device ID, password, tokens, etc.), the DRM server may check whether the license of the consumer is still valid. If that is the case, the DRM server may send a manifest file back to the DRM module (step 308). Preferably, the manifest file is sent over a secure channel, e.g. a SSL channel to the DRM module. In an embodiment, the manifest file may comprise at least segment identifiers and content keys associated with the segment identifiers as described in detail with reference to FIG. 2.

In another embodiment, the DRM server may send all or at least part of the content keys separately from the manifest file to the DRM module.

The DRM module may then parse the manifest file and determine the location information, e.g. URLs, associated with one or more content delivery nodes which are configured to deliver segments identified in the manifest file to a requesting client (step 310). The DRM module may subsequently send at least part of the segment identifiers and location information to the client (step 312). The client may send a first request message, e.g. a HTTP GET message, comprising a first segment identifier, to a delivery node, in this case e.g. an HTTP media server (step 314). The delivery node may send the requested encrypted segment back to the client (step 316). In one embodiment, the segment may be send in a first response message, e.g. an HTTP 200 OK message, to the client. The client may forward the encrypted segment to the DRM module (step 318), which performs the steps of: relating the encrypted segment with an associated content key, decrypting the encrypted data of the segment into cleartext on the basis of the content key (step 320) and decoding the segment data so that the content processing device is able to display the data to the consumer.

Meanwhile the process of requesting further segments may continue. For example, during the processing (e.g. decryption or decoding) of the first segment, a second request message comprising a second segment identifier may be sent to the delivery node (step 322), which in return may send a second encrypted segment to the client (step 324). The second (encrypted) segment may be forwarded to the DRM module for decryption and further processing (steps 326, 328). This process may be repeated for all or at least part of the segments identified in the manifest file or until the consumer aborts the play-out process.

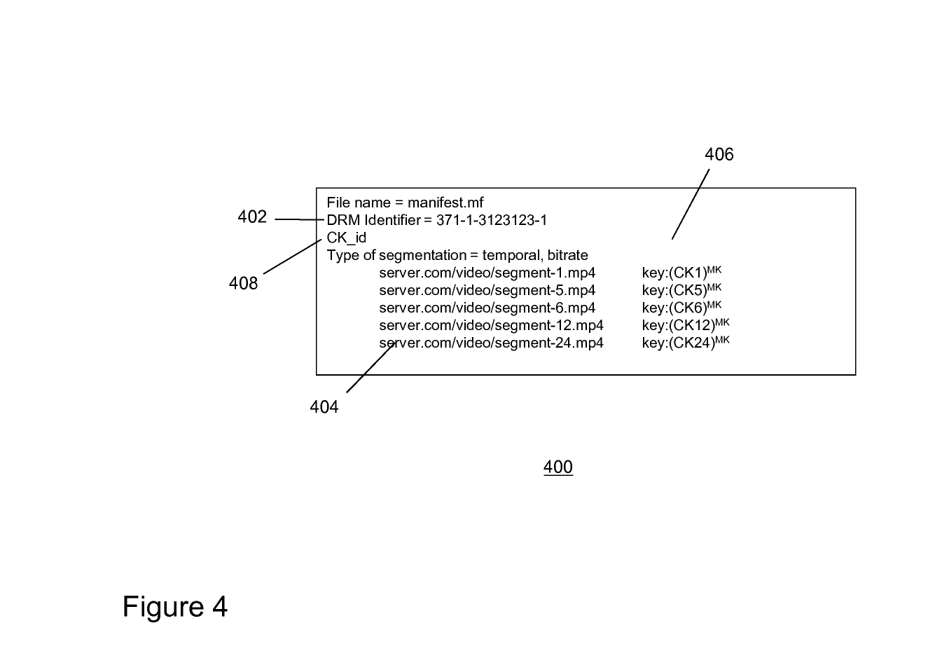

FIG. 4 depicts a schematic of at least part of a manifest file 400 according to another embodiment of the invention. The manifest file may define a content item or a content collection. The manifest file may comprise one or more segment identifiers 404 (e.g. segment file names) and location information for locating segments associated with the one or more segment identifiers in the network. In an embodiment, the manifest file may further comprise DRM identification information 402 which may be used by the DRM module to identify information associated with a content item that is stored in the DRM server.

The manifest file may further comprise key information for enabling decryption of encrypted segments identified by the segment identifiers. In this particular embodiment, the key information may comprise at least part of the content keys CKs in encrypted form or a reference, e.g. an URL or a network address, to a network location where these encrypted content keys are stored.

The content keys CKs may be encrypted using a Manifest Key, which may be unique for one manifest file or for a set of related manifest files and may be used for encrypting all or at least a part of the CKs that are associated with one manifest file. In addition, in one embodiment, the MK may also be used to encrypt (part of) other information that may be present in the manifest file, e.g. segment identifiers, location information and/or DRM ID.

When a DRM module receives the encrypted content keys (CK)^{MK} it requires a Manifest Decryption Key MDK (e.g. a manifest specific decryption key) to decrypt encrypted CKs. The MK and MDK may be used by a DRM system to control access to all segments that are referenced in a single manifest (and thus part of the same content item). For example, two different manifest files, which define two different content items and/or content collections, may contain references to the same encrypted segments, wherein the CKs for these segments are encrypted using different MKs.

In one embodiment, at least part of the encrypted CKs may be stored together (e.g. associated) with the segment identifiers in the manifest file. In another embodiment, the manifest file may comprise a reference to a network location, e.g. an URL or an network address, where at least part of the MK-encrypted CKs are stored.

In a further embodiment, the key information may comprise one or more key identifiers 408. A key identifier may be linked to the (encrypted) keys in the manifest file and may be used by the DRM module in order to provide replay protection. In one embodiment, the key identifier may have the form of a sequence number. In another embodiment, the key identifier may be nonce or a time stamp, e.g. an NTP time stamp. The key identifier prevents re-use of intercepted key information at a later time.

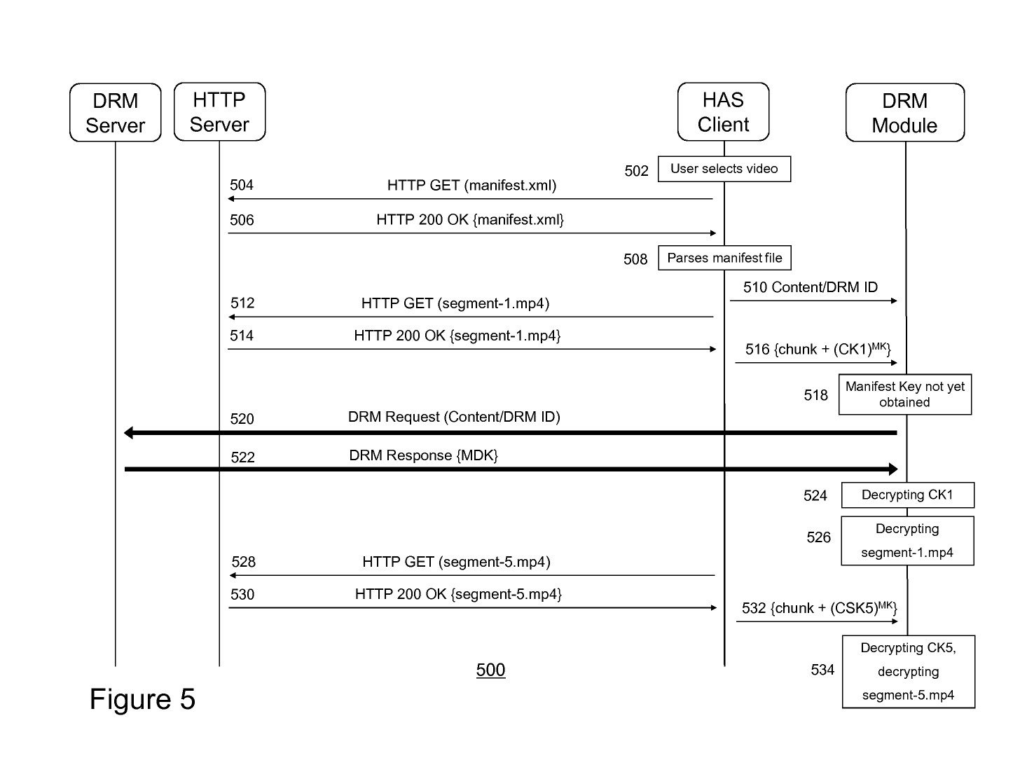

FIG. 5 depicts a protocol flow of a DRM-protected streaming process according to an embodiment of the invention.

The protocol flow may be executed by a content delivery system, which may comprise at least a delivery node (e.g. an HTTP media server) comprising encrypted segments and a content processing device comprising a client (e.g. a HAS or an MPEG DASH client) and a DRM system comprising DRM server and a DRM module which is implemented in the content processing device and which is configured to communicate with the client.

The content delivery system may be configured to process segmented content items or content collections, which are defined on the basis of a manifest file comprising segment identifiers which are associated with encrypted content keys (for decryption of segments). In one embodiment, at least part of the content keys may be encrypted using a Manifest Key (MK) as described with reference to FIG. 4.

The process may start by the user selecting a video (step 502) in as similar was as described with reference to FIG. 3. For example, the customer may buy a content item or content collection, e.g. a (personalized) video title, via a website of a content provider. When concluding a transaction, the customer may obtain a license comprising access rights for accessing the content item. In order to identify these rights and to associate these rights to the content item and the customer, DRM identification information (DRM ID) may be generated and stored in the DRM server.

After obtaining the license, the customer may—at some point in time—decide to play-out the content item or content collection by instructing the client in the content processing device, e.g. by pressing a play button.

In response, the client may send a manifest request comprising a content identifier (content ID, e.g. the name of the content item) to the delivery node (step 504). In response the delivery node may send a manifest file associated with content item or content collection back to the client (step 506). In one embodiment, the manifest file may comprise segment identifiers, location information associated with the segment identifiers and MK-encrypted content keys (CK)^{MK}. The client may parse the information in the manifest file (step 508) and forward the content identifier and DRM identification information to the DRM module (step 510).

On the basis of the manifest file, the client may start requesting segments from the network. To that end, it may send a first segment request, e.g. an HTTP request message, comprising a segment identifier (e.g. a segment file name such as segment-1.mp4) to the delivery node (step 512). If the delivery node has the identified segment in store, it may forward the requested encrypted segment in a first segment response message, e.g. an HTTP response message, to the client (step 514).

The client may subsequently forward the encrypted segment and the associated encrypted content key to the DRM module (step 516). In case the DRM module does not have a Manifest Decryption Key for decrypting the encrypted content keys (step 518), it may start a DRM right exchange in a similar way as described with reference to FIG. 3.

The DRM right exchange process may include the transmission of a content access request message (DRM request), comprising a content ID, a DRM ID and/or further validation information (e.g. user- or device ID, password, tokens, etc.) to the DRM sever (step 520), which will check whether user has the right to access the content item. If the request is approved by the DRM server, it may authorize the content processing device by sending the Manifest Decryption Key (in a secure way) to the DRM client (step 522). In one embodiment, the MDK is sent in a DRM response message to the DRM client. The MDK allows the DRM client to decrypt the encrypted content key (CK1)^{MK} which is needed for decrypting encrypted segments, e.g. a first encrypted segment segment-1.mp4 (steps 524, 526). Once decrypted, the plaintext segment data may be decoded and displayed to the user (not shown).

Meanwhile, the client may request further segments by sending a second segment request message comprising a segment identifier of a further segment segment-5.mp4 to the delivery node (step 528). In response the delivery node may forward the requested encrypted segment segment-5.mp4 to the client (step 530). The client may forward the encrypted segment together with the associated encrypted content key (CK5)^{MK} via the secure interface to the DRM module (step 532). The DRM module may subsequently decrypt the encrypted content key on the basis of the MDK and decrypt the encrypted segment on the basis of the decrypted content key (step 534). This process may be repeated for all or a part of the segments listed in the manifest file. The process of retrieving, decrypting, decoding segments is timed by the client such that seamless displaying of segment data is assured as much as possible.

Hence, as clearly illustrated in FIG. 5, only a client that has access rights for a given content item or content collection will be provided with a Manifest Decryption Key MDK in order to decrypt the content keys CKs that are included in or associated with the segment identifiers in the manifest file. The segment-based encryption scheme including an MK encryption layer as e.g. described with reference to FIG. 5 thus allows implementation of a flexible DRM system for segmented content, wherein the same segments may be used in different collections.

For example, a content collection associated with a summary of the football match may be defined by a first manifest file, which identifies a predetermined subset of the set of encrypted segments defining a content item of the whole match. The subset of the segments identified in the first manifest file, may also be used in a manifest file associated with the content item comprising the complete football match.

Hence, the manifest files of the content item and the content collection may both refer in part to the same segments that are stored or made available on a delivery node. A segment that is shared by the content item and content collection is encrypted with the same content key. The first and second manifest files, or at least the key information contained in the first and second manifest files, however are encrypted with different first and second manifest keys respectively. Therefore, a user who has the right to the summary only will receive the Manifest Decryption Key associated with the second manifest file. It can only decrypt CKs that are included in or associated with the “summary” manifest file. This way, even if that user would gain (illegitimate) access to the manifest file describing the entire football match, it would be useless, since without the associated Manifest Decryption Key it is not possible to decrypt the CKs listed in that manifest file.

A further advantage of the MK layer is therefore that it makes sure that the manifest files themselves can be distributed freely. This allows the manifest file to be distributed over a regular CDN, in unprotected form. The same holds for the segments. The only data that has to be distributed over a secure channel, e.g. the secure DRM channel, is the manifest key MK, thereby limiting the load on the DRM provider (and the associated cost).

In a further embodiment, the content provider or CDN may “sign” the manifest file. Signing in this context means calculating a hash over the manifest file using a well-known public-private key scheme. The secure DRM module in a content processing device may use a public key to check whether the manifest file has been tampered with, and reject any request for using the MK to decrypt the CKs in that manifest file. The advantage of such a mechanism is that it prevents third parties (or malicious clients) from creating new manifest files using segments to which they have access to (e.g. creating a third party summary manifest file based on segments, and CKs, that were obtained earlier).

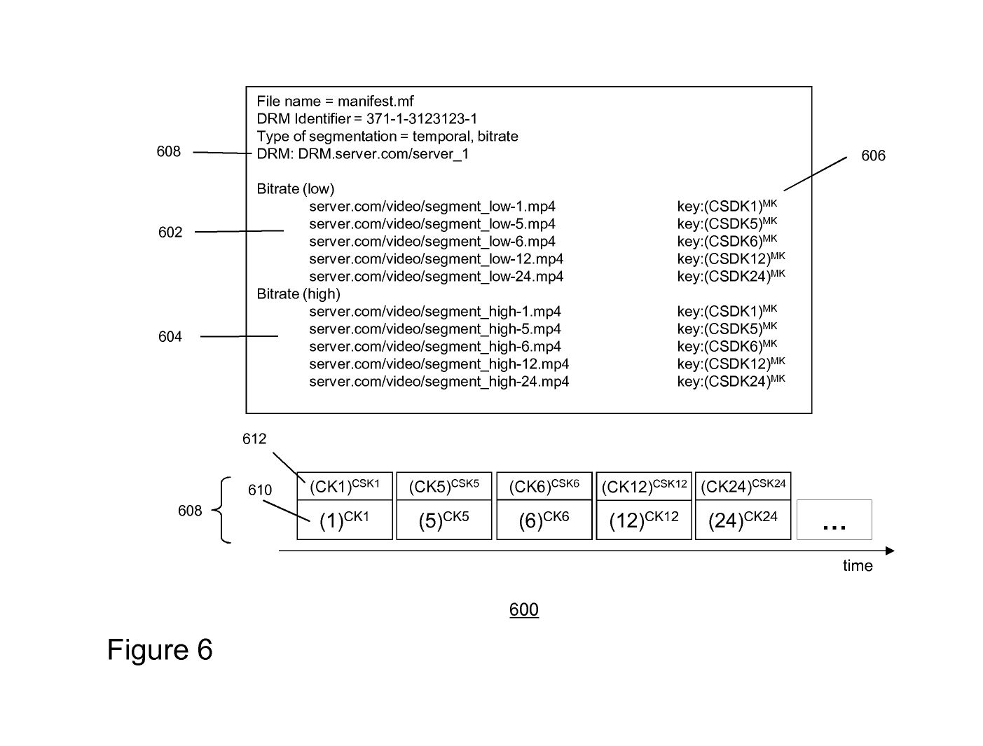

FIG. 6 depicts a schematic of at least part of a manifest file 600 according to another embodiment of the invention. The manifest file may define a content item or a content collection as described in detail with reference to FIG. 1B. The manifest file may comprise one or more segment identifiers 604, e.g. segment file names and for locating segments associated with the one or more segment identifiers in the network. In an embodiment, the manifest file may further comprise DRM identification information 602 which may be used by the DRM module to identify information associated with a content item that is stored in the DRM server.

In this particular embodiment, the manifest file may define (two or more) different sets of segment identifiers, wherein each set is associated with a different representation of a content item or a content collection. For example, a first set of segment identifiers 602 may be associated with first representation of a content item or content collection, e.g. low-bitrate segments forming at least part of a low-quality video title; and, a second set of segment identifiers 604 may be associated with a second representation of a content item or content collection, e.g. high-bitrate segments forming at least part of a high-quality version of the same video title. Such manifest file enables the content processing device to switch between different representations (e.g. a high- and low bitrate, different viewing angles, different advertisements, different audio and/or subtitles) of the same content item or content collection.

The segments identified in the manifest file may be encrypted on the basis of content keys CKs in a similar way as described above and stored in encrypted form in the network. In this particular embodiment however, the content keys may be encrypted on the basis of Chunk Specific Keys (CSKs), wherein one CSK may be unique for one segment or a set of related segments.

For example, as depicted in FIG. 6, a first CSK may be used for encrypting a first and second representation of a particular segment (e.g. CSK1 associated with low-bitrate segment segment_low-1.mp4 and its associated high-bitrate segment segment_high-1.mp4).

In order for the DRM module to decrypt segments identified in the manifest file, the manifest file may comprise key information. In one embodiment, the key information may comprise (optionally MK-encrypted) Chunk Specific Decryption Keys (CSDK) associated with the segment identifiers. In another embodiment, the key information may comprise a reference, e.g. an URL or an network address, to a location where the Chunk Specific Decryption Keys (CSDK) associated with the segment identifiers are stored, e.g. a key server. Such reference may optionally comprise an identifier of the specific key itself.

On the basis of the key information in the manifest file (MK-encrypted) Chunk Specific Decryption Keys (CSDK) may be provided to the DRM module, which may use the CSDKs to decrypt the CSK-encrypted content keys (CK)^{CSK} and use the CKs to decrypt the encrypted segments.

The advantage of introducing an encryption layer on the basis of the CSKs is that it improves compatibility with existing content protection schemes, which have (part of) the encryption (decryption) keys (e.g. scrambling keys) embedded in the video container itself (as depicted in FIG. 6).

For example, in one embodiment, the content key CK of a segment (i.e. the key for decrypting an encrypted segment) may be encrypted itself, using a CSK and the thus encrypted content key (CK)^{CSK} 612 may be sent to the content processing device in a data format 608 that is also used to deliver the encrypted segment 610. For example, an encrypted content key (CK)^{CSK} may be delivered or stored as part of an mp4 file box or an MP2TS file comprising a segment that is encrypted using the content key.

In a further embodiment, the manifest file may comprise DRM identifier and/or DRM location information 608, e.g. an URL, URI or network address, associated with the DRM server. Hence, when the client receives the manifest file it may parse the file and forward the DRM identifier and/or location information to the DRM module, which may use this information to send a DRM request to the DRM server identified in the DRM identifier and/or location information.

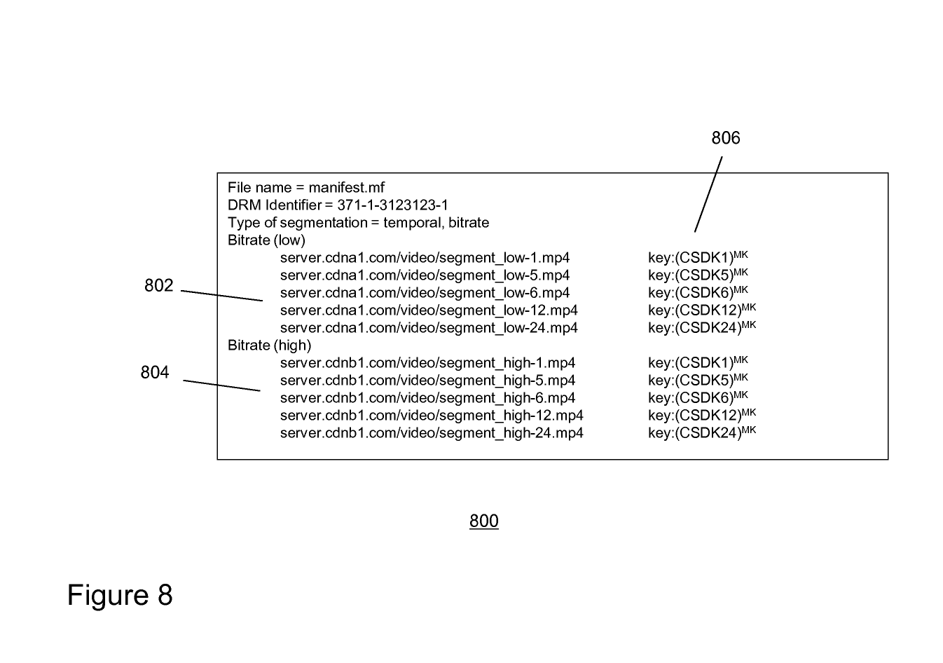

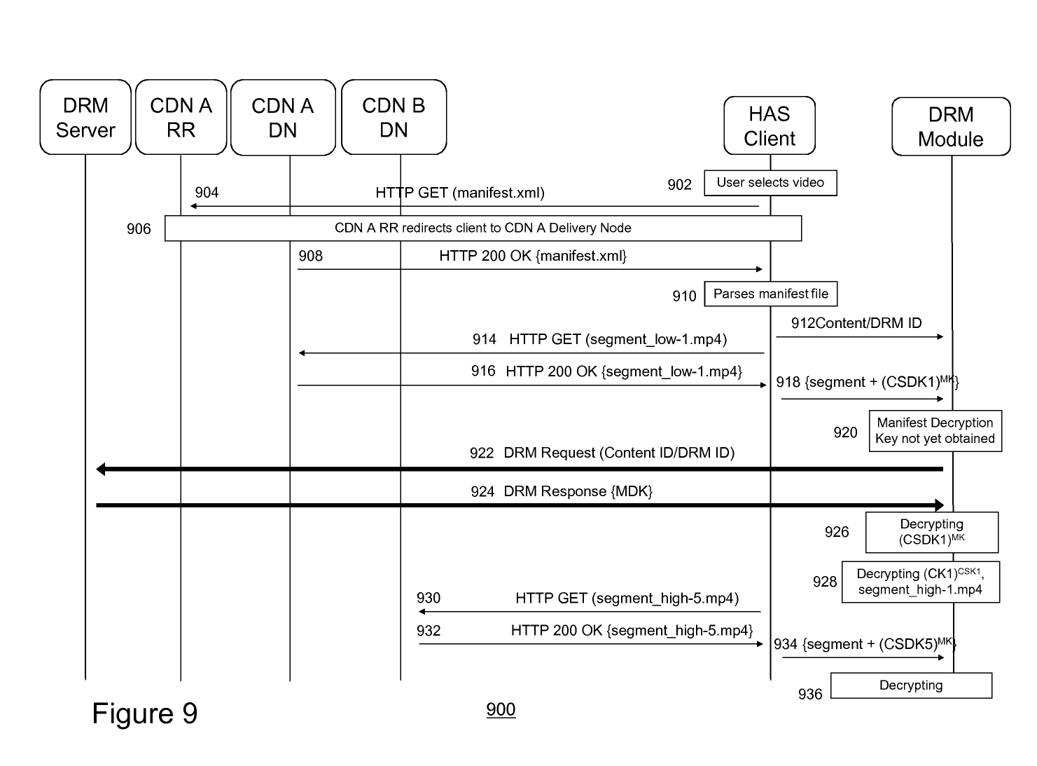

A more detailed description of the use of the manifest file described with reference to FIG. 6 is described hereunder in more detail with reference to FIGS. 8 and 9.

In addition to encrypting the CK or CSK, the MK may also be used to encrypt other parts of the manifest file, or even the entire manifest file. The use of such encryption scheme may guarantee that if a user would get illegitimate access to the manifest file, it would not be possible (or at least it would be very hard) to reconstruct the proper ordering of segments for that particular content item.

The MDK used in the above-described embodiments may be distributed to the DRM-modules of content processing devices in encrypted form with a user-specific or device-specific key that is delivered when the content is purchased or ordered. This way a further security layer may be formed which is device- or user-specific. An advantage of this embodiment is that it may allow a content provider to make sure that a given content item is only played out on a specific device.

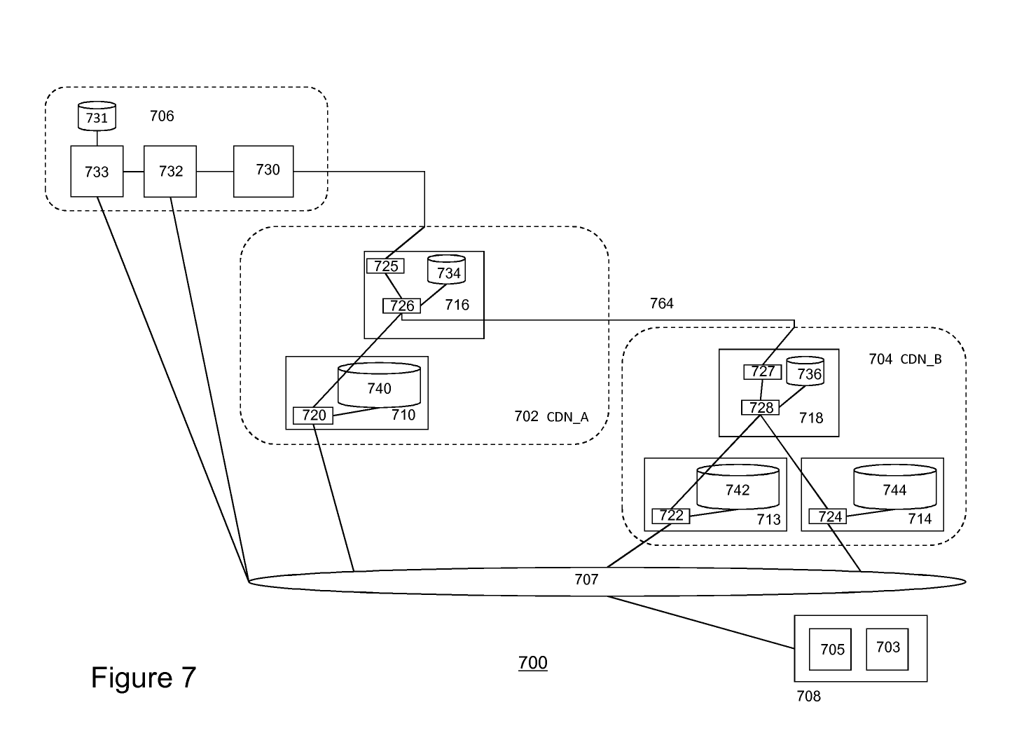

FIG. 7 depicts a content delivery system 700 comprising a DRM system according another embodiment of the invention. In particular, FIG. 7 illustrates a CDN-based content delivery system comprising a first CDN 702 (also referred to as the upstream CDN) and a second CDN 704 (also referred to as the downstream CDN), which are configured to deliver DRM-protected content to a content processing device. The first and second CDN may be interconnected via a CDN interconnect interface 764. The content delivery system may further comprise or be associated with a content source (CS) 706 connected via a transport network 707 to one or more content processing devices 708. A content processing device may comprise a (HAS) client 703 and a DRM module 705 (as described in detail with reference to FIG. 1).

The content source may be implemented as a content provider system CPS 730, a content preparation system or another CDN. A CPS may be configured to offer content, e.g. video titles, via a web portal (WP) 732 to customers. Purchased access rights to content items may be stored via a DRM server 733 in a DRM database 731. A customer may purchase a content item via the web portal and access the content using the HAS client and a DRM module in the content processing device.

A CDN may comprise delivery nodes 710,713,714 and at least one central CDN node 716,718. Each delivery node may comprise or be associated with a controller 720,722,724 and a cache 740,742,744 for storing and buffering content. Each central CDN node may comprise or may be associated with an ingestion node (or content origin function, COF) 725,727 for controlling ingestion of content from an external source, e.g. a content provider or another CDN, a content location database 734,736 for maintaining information about where content is stored within a CDN and a CDN control function (CDNCF) 726,728 for controlling the distribution of one or more copies of the content to the delivery nodes and for redirecting clients to appropriate delivery nodes (a process also known as request routing).

In one embodiment, the node hosting the CDNCF may be referred to as the request routing (RR) node. A customer may purchase content, e.g. video titles, from a CPS 730 by sending a request to a web portal (WP) 732, which is configured to provide title references identifying purchasable content items. The CDNCF may manage the locations where segments may be retrieved using the content location database 734,736.

In the content delivery system of FIG. 7, the upstream CDN may outsource part of the delivery of segments to a client to the downstream CDN. For example, in one embodiment, low-quality segments may be located and delivered by a first CDN A (configured e.g. for delivery of content to mobile devices) and high quality segments may be located and delivered by a second CDN B (configured e.g. for delivery of high-quality segments to home media devices supporting HDTV or HbbTV technology).

An embodiment of at least part of a manifest file for use in such content delivery system is depicted in FIG. 8. The manifest file may define a content item or a content collection as described in detail with reference to FIG. 1B. The manifest file may be (at least in part) similar to the manifest file described with reference to FIG. 6 comprising one or more set of segment identifiers 802,804 associated with one or more representations of a content item (e.g. a low bitrate and high bitrate version of a video title) and location information associated with delivery nodes which are configured for delivering segments that are identified in the manifest file. The manifest file may further comprise key information for enabling decryption of segments identified in said manifest file.

In one embodiment, the key information may comprise (MK-encrypted) Chunk Specific Decryption Keys CSDKs 806 associated with the segment identifiers. In another embodiment, the key information may comprise a reference, e.g. an URL or a network address, for locating a network element, e.g. a key server, where the CSDKs are stored. These CSDKs are described in detail with reference to FIG. 6.

In contrast with the manifest file in FIG. 6, the location information, e.g. the URLs, associated with refer to different content delivery networks, e.g. CDN A and CDN B wherein CDN A may be configured for delivering the low-bitrate (encrypted) segments and CDN B is configured for delivering the high-bitrate (encrypted) segments.

FIG. 9 depicts a protocol flow of a DRM-protected streaming process according to yet another embodiment of the invention. The protocol flow may be executed by a content delivery system comprising a DRM system and a network system comprising one or more CDNs (in this case a first CDNA and a second CDNB), wherein the CDNs are configured to deliver segments associated with a content item to multiple content processing devices. An embodiment of such content delivery system is described in more detail with reference to FIG. 7. Such content delivery system may be configured to control the streaming of a DRM-protected segmented content item to a client on the basis of a manifest file as described with reference to FIG. 8. In that case, CDNA may for example be configured to deliver low bit rate segments of a content item and CDNA may be configured to deliver high bit rate segments of the same content item.

The process may start by the user selecting a video (step 902) using a method which is similar to the one described with reference to FIG. 3. For example, the customer may buy a content item or content collection, e.g. (personalized) video title, via a website of a content provider. When concluding a transaction, the customer may obtain a license comprising access rights for accessing the content item or content collection. For example, a customer may obtain the rights for access both the low and high bit rate versions of a content item.

In order to identify these rights and to associate these rights to the content item and a customer, DRM identification information (DRM ID) may be generated and stored in the DRM server. After obtaining the license, the customer may—at some point in time—decide to play-out the content item or content collection by instructing the client in the content processing device (e.g. by pressing a play button).

In response, the client may send a manifest request message comprising a content identifier (content ID, e.g. the name of the content item) to the first (upstream) CDNA, in particular a request routing (RR) node of CDNA (step 904). The RR node may determine a delivery node in the CDNA, which is capable of delivering a manifest file associated with the requested content item to the client. When locating a suitable delivery node, the RR node may redirect the manifest request message to a delivery node, which is identified by the RR node (step 906). The delivery node may respond to the manifest request message by sending a response message, e.g. an HTTP response message, comprising the manifest file to the client (step 908). The manifest file may comprise segment identifiers and location information associated with one or more delivery nodes configured for delivering segments identified by said segment identifiers. The manifest file may further comprise (MK-encrypted) Chunk Specific Decryption Keys (CSDKs), which are associated with the segment identifiers.

If the customer has obtained the right to access multiple representations of a content item or content collection, e.g. low and high bit rate versions, the manifest file may comprise segment identifiers and location information associated with one or more delivery nodes configured for delivering segments identified in said manifest file.

In one embodiment, the manifest file may further comprise key information comprising Chunk Specific Decryption Keys (CSDKs) associated with different sets of segment identifiers wherein each set may be related to a particular representation of a content item or content collection (e.g. low bit rate segments delivered by CDNA and high bit rate segments delivered by CDNB) as described in detail with reference to FIG. 8.

The client may parse the information in the manifest file (step 910) and forward the content identifier and DRM identification information to the DRM module (step 912).

The client may further send a first segment request, e.g. an HTTP request message, comprising a segment identifier (e.g. a segment file name segment_low-1.mp4) to the delivery node of CDNA (step 914) in order to request delivery of a first (low bit rate) segment. If the delivery node has identified the first segment in store, it may forward the requested first segment (which is encrypted by a predetermined first content key CK1) in a first segment response message, e.g. an HTTP response message, to the client (step 916).

In an embodiment, a CSK-encrypted content key (CK1)^{CSK} may be sent together with the encrypted first segment to the client. In another embodiment, the CSK-encrypted content key (CK1)^{CSK} may be sent in a separate secure channel to the client. The client may subsequently forward the encrypted segment, the CSK-encrypted content key (CK1)^{CSK1} and the associated Chunk Specific Decryption Key CSDK1 to the DRM module (step 918). In one embodiment, the CSDK may be encrypted using a Manifest Key thereby forming an MF-encrypted Chunk Specific Decryption Key (CSDK1)^{MK}.

In case the DRM module does not have a Manifest Decryption Key (e.g. a manifest specific decryption key) for decrypting the MF-encrypted CSDK, it may start a DRM right exchange in a similar way as described with reference to FIGS. 3 and 5. The DRM right exchange process may include the transmission of a content access request message (DRM request) comprising a content ID and a DRM ID to the DRM sever (step 922), which will check whether user has the right to access the content item. If the request is authorized by the DRM server, it may send a DRM response message comprising the Manifest Decryption Key MK to the DRM client (step 924).

On the basis of the MDK, the DRM client may decrypt the encrypted first Chunk Specific Decryption Key (CSDK1)^{MK} into a plaintext first chunk specific decryption key CSDK1 (step 926) and use the CSDK1 to decrypt the CSK-encrypted first content key (CK1)^{CSK1} into a plaintext first content key CK1. First content key CK1 is then used to decrypt the encrypted segment segment_low-1.mp4 (steps 928). Once decrypted, the plaintext segment data of the first (low bit rate) segment may be decoded and displayed by the content processing device to the user (not shown).

Meanwhile, the client may request further segments. User interaction with the content processing device may signal the client that the user wants to switch to a different representation (e.g. from a low bit rate representation to a high bit rate representation of the content item or content collection). To that end, the client may send a second segment request message comprising a segment identifier of a further segment segment_high-5.mp4 to a delivery node in CDN B (step 930), which is configured to deliver the high bit rate segments of the content item.

The delivery node in CDNB may forward the requested high bit rate segment in a response message to the client (step 932). The client may extract the encrypted segment segment_high-5.mp4 and forward it together with the associated encrypted chunk specific decryption key (CSDK5)^{MK} via the secure interface to the DRM module (step 934). The DRM module may subsequently decrypt (CSDK5)^{MK} and use the resulting key CSDK5 to decrypt the encrypted content key and then decrypt the decrypted segment on the basis of the decrypted content key (step 934). This process may be repeated for all or a part of the segments listed in the manifest file. The process of retrieving, decrypting, decoding segments is timed by the client such that seamless displaying of segment data is assured as much as possible.

Note that in this embodiment, the manifest file comprises location information (URLs) of a specific delivery node in CDN A, which is configured to directly deliver a segment to a requesting client. In another embodiment, the manifest file could comprise references to the request routing node of CDN A or CDN B, which may determine per request which specific CDN delivery node within CDN A or CDN B may be selected to deliver the requested segment. This way the CDN RR node may select a particular CDN delivery node on the basis of traffic and/or load information associated with CDN delivery nodes in the particular CDN. This way the CDN is able to perform load-balancing.

In the embodiment described with reference to FIG. 1-9, the specific embodiments have been described with respect to manifest files that use sets of segments wherein each set may form a different representation of a content item or content collection, e.g. high- and low bitrate, multiple angle, etc.

The present invention may also be applied to segments that relate to spatial content in a video. In spatially segmented video content, video frames in an (original) video file are spatially subdivided into video tiles. The temporal sequence of a tile of a certain spatial position may be stored as a segment. A tiled or spatially segmented video is schematically depicted in FIG. 10. Frames of a video 1002 may for example be subdivided into 4×4 tiles 1004, wherein each tile is related to a certain spatial position in the frame of the original video. Different users may have different rights for accessing the tiles. For example one user may only have the rights to access the four centre tiles 1006 while another user may have the rights to all 16 tiles.

In addition, the present invention may also be applied to segments that are intended to be played simultaneously, such as audio or as a graphical overlay such as subtitles or a quality enhancement overlay. Different users may have different rights with respect to the language of the subtitle or audio tracks. The present invention enables flexible management of the rights for accessing a subset of segments selected from a set of segments defining a content item; or, for accessing segments selected from sets of segments defining different content items. The invention is particular advantageous for delivering DRM-protected personalised content to a content delivery device.

It is submitted that the sequence of steps in the flows depicted in FIGS. 3,5 and 9 is non-limiting and many variations are possible without departing the invention. For example, the DRM right exchange process may be started by the DRM module after the client has forwarded the content ID and DRM ID to the DRM. Further, the content ID and DRM ID may be sent to the DRM module together with the encrypted segment and content key to the DRM module. The same holds for the information in the manifest files as described with reference to FIGS. 2,4,6 and 8. For example, a manifest file may comprise location information (URL or URI) associated with a DRM server and/or key identifiers.

It is to be understood that any feature described in relation to any one embodiment may be used alone, or in combination with other features described, and may also be used in combination with one or more features of any other of the embodiments, or any combination of any other of the embodiments. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. The invention is not limited to the embodiments described above, which may be varied within the scope of the accompanying claims.

1. A method for enabling delivery of one or more digital rights management (DRM) protected segments to a content processing device, wherein said segments are associated with a manifest file, said manifest file comprising at least a first segment identifier associated with a first segment encrypted on the basis of a first key; a second segment identifier associated with a different, second, segment encrypted on the basis of a second key; and, preferably said manifest file defining a content collection wherein said first and second segments are a subset from a set of segments that are stored in the network; said manifest file further comprising key information for enabling decryption of at least one of said first and second encrypted segments, wherein at least part of said key information is encrypted on the basis of a manifest-specific encryption key, said method comprising:
a secure module, preferably a DRM module, in said content processing device requesting a DRM server access to at least part of said segments; and,
providing said secure module access to at least part of said key information, if said content access request is granted by said DRM server, said providing comprising:
said secure module receiving a manifest-specific decryption key for decrypting said encrypted part of said key information.

2. Method according to claim 1, comprising:
said secure module receiving said key information, said key information comprising at least one of a first and second decryption key for decrypting said first or said second segment respectively; or, said key information comprising a reference, preferably an resource locator or a network address, to a network entity comprising at least one of a first and second decryption key, if said content access request is granted by said DRM server.

3. Method according to claim 1 wherein said first and second decryption keys are different keys.

4. Method according to claim 1, wherein said first key is encrypted using a first segment-specific encryption key and wherein said key information comprises a first segment-specific decryption key for decrypting said encrypted first key.

5. Method according to claim 4, wherein said method comprises:
receiving said encrypted first segment and said encrypted first key; preferably said encrypted first segment and said first encrypted first key being received using the same (MPEG-based) data container;
receiving said first segment-specific decryption key;
decrypting said encrypted first key on the basis of said first segment-specific decryption key;
decrypting said encrypted first segment using said first key.

6. Method according to claim 1 wherein said manifest file further comprises location information associated with a delivery node for delivering said first and/or second segment; and, optionally, said method further comprising:
sending a request for the delivery of a segment to said delivery node;
receiving said first and/or second encrypted segment;
decrypting said first and/or second encrypted segment on the basis of said key information.

7. Method according to claim 1, wherein said content processing device comprises: a client, preferably a HAS client, configured for requesting and receiving encrypted segments from the network on the basis of said manifest file; and/or, a secure module, preferably a DRM module, configured for requesting a DRM server a right to access at least part of the encrypted segments and for receiving at least part of said key information from said DRM server.

8. Method according to claim 1, wherein said encrypted segments are delivered by at least one content delivery network, preferably one or more delivery nodes in said at least one content delivery network, to said content processing device.

9. A system for enabling delivery of one or more digital rights management (DRM) protected segments to a content processing device, wherein said segments are associated with a manifest file, said manifest file comprising at least a first segment identifier associated with a first segment being encrypted on the basis of a first key, and a second segment identifier associated with a second segment being encrypted on the basis of a second key; and segment play-out information; said manifest file further comprising key information for enabling decryption of at least one of said first and second segment, at least part of said key information being encrypted with a manifest specific encryption key; preferably said manifest file defining a content collection wherein said first and second segments are a subset from a set of segments that are stored in the network; said system comprising:
a secure module, preferably a DRM module in said content processing module, configured for requesting a DRM server access to at least one of said segments; and,
a DRM server configured for providing said secure module with a manifest specific decryption key for decrypting said encrypted part of said key information, if said content access request is granted by said DRM server.

10. A DRM module for digital rights management of one or more DRM protected segments, wherein said segments are associated with a manifest file, comprising at least a first segment identifier associated with a first segment being encrypted on the basis of a first encryption key; a second segment identifier associated with a second segment being encrypted on the basis of a second encryption key; and, segment play-out information; preferably said manifest file defining a content collection wherein said first and second segments are a subset from a set of segments that are stored in the network; said manifest file further comprising key information for enabling decryption of at least one of said first and second segment, at least part of said key information being encrypted on the basis of a manifest-specific encryption key, said module comprising:
a transmitter for sending a content access request for accessing at least at least one of said segments to a digital rights server;
a receiver for receiving at least part of said key information if said content access request is granted by said digital rights server; and/or for receiving a manifest specific decryption key for decrypting said encrypted part of said key information, if said content access request is granted by said DRM server;
a decryption module, for decrypting at least one of said first or second encrypted segments on the basis of said key information.

11. A content processing device for receiving one or more DRM-protected segments, wherein said content processing device is configured to receive said one or more segments on the basis of a manifest file, said manifest file comprising at least a first segment identifier associated with a first segment being encrypted on the basis of a first encryption key; a second segment identifier associated with a second segment being encrypted on the basis of a second encryption key; preferably said manifest file defining a content collection wherein said first and second segments are a subset from a set of segments that are stored in the network; said manifest file further comprising key information for enabling decryption of at least one of said first and second segment, at least part of said key information being encrypted on the basis of a manifest-specific encryption key, said content processing device comprising:
a client, preferably a DASH client, configured for requesting and receiving said first and/or second encrypted segment on the basis of said manifest file;
a DRM module according to claim 10, configured for receiving said first and/or second encrypted segment from said client, for receiving at least part of said at least partly encrypted key information from said client; and/or, for decrypting at least part of said first and/or second encrypted segment using at least part of said key information.

12. A data structure, preferably a manifest file for use by a content processing device according to claim 11, said data structure enabling digital rights management of one or more DRM protected segments, wherein said one or more segments are associated with a manifest file, said manifest file comprising at least a first segment identifier associated with a first segment being encrypted using a first key; a second segment identifier associated with a second segment being encrypted using a second key; and, segment play-out information, preferably said manifest file defining a content collection wherein said first and second segments are a subset from a set of segments that are stored in the network; said manifest file further comprising key information for enabling decryption of said at least one of said first and second segment.

13. A data structure according to claim 12, wherein said key information comprises:
at least one of a first and second decryption key for decrypting said first or said second segment respectively; or, wherein said key information comprises a reference, preferably an resource locator or a network address, to a network entity comprising said first and/or second decryption key;
or, wherein said key information comprises:
a first segment specific decryption key and/or second segment specific key; or a reference to said first and/or second segment specific decryption key, said first and second segment specific decryption key suitable for decrypting said first and second key respectively;
and/or, wherein said key information or at least a part of said manifest file comprising said key information is encrypted using a manifest key, preferably said manifest key being a manifest specific encryption key.

14. Computer program product, a computer program product comprising software code portions configured for, when run in the memory of a computer, executing the method steps according to claim 1.
